(19) United States
(12) Patent Application Publication
(10) Pub. No.: US 2013/0265876 A1
(43) Pub. Date: Oct. 10, 2013

(54) APPARATUS AND METHOD FOR CONTROLLING PACKET FLOW IN MULTI-STAGE SWITCH

(71) Applicant: ELECTRONICS AND TELECOMMUNICATIONS RESEARCH IN, Daejeon-si (KR)

(72) Inventors: Jong-Tae SONG, Daejeon-si (KR); Yool KWON, Daejeon-si (KR); Kyung-Gyu CHUN, Daejeon-si (KR); Heuk PARK, Daejeon-si (KR); Nam-Seok KO, Daejeon-si (KR); Hea-Sook PARK, Daejeon-si (KR)

(73) Assignee: Electronics and Telecommunications Research Institute, Daejeon-si (KR)

(21) Appl. No.: 13/682,135

(22) Filed: Nov. 20, 2012

(30) Foreign Application Priority Data
Apr. 6, 2012 (KR) 10-2012-0036303

(51) Int. Cl. H04L 12/56

(52) U.S. Cl. CPC H04L 47/10
USPC 370/235

(57) ABSTRACT

Provided are an apparatus and method for controlling packet flow in a multi-stage switch. According to an aspect, there is provided an apparatus for controlling packet flow in a multi-stage switch, including: one or more source line cards configured to receive one or more packets, and to transfer the one or more packets to a switch fabric including a plurality of switch modules forming one or more switching stages such that the one or more packets are transferred along different switching paths in the switch fabric; and a destination line card configured to receive the one or more packets output from the switch fabric, and to transfer Acknowledge (ACK) messages for informing that the packets have been received, to the source line cards, in a predetermined time period.

### CROSS-REFERENCE TO RELATED APPLICATION

This application claims the benefit under 35 U.S.C. §119(a) of Korean Patent Application No. 10-2012-0036303, filed on Apr. 6, 2012, the entire disclosure of which is incorporated herein by reference for all purposes.

### BACKGROUND

1. Field

The following description relates to a switch device, and more particularly, to a multi-stage switch and a control method thereof.

2. Description of the Related Art

It is not easy to design a switch architecture having a large capacity and high cost efficiency. Since the number of crosspoints of a switch is proportional to the square of the number of ports of the switch, a single-stage switch architecture is not suitable as technology for a large-scale switch. Meanwhile, a multi-stage switch architecture such as a Clos network can achieve good expandability and high cost efficiency since it can reduce the number of crosspoints and allows interconnections.

### SUMMARY

The following description relates to an apparatus and method for controlling packet flow based on a window in a multi-stage switch.

The following description also relates to an apparatus and method for controlling packet flow based on a window in a multi-stage switch, using time-division multiplexing (TDM) technology.

In one general aspect, there is provided an apparatus for controlling packet flow in a multi-stage switch, including: one or more source line cards configured to receive one or more packets, and to transfer the one or more packets to a switch fabric including a plurality of switch modules forming one or more switching stages such that the one or more packets are transferred along different switching paths in the switch fabric; and a destination line card configured to receive the one or more packets output from the switch fabric, and to transfer Acknowledge (ACK) messages for informing that the packets have been received, to the source line cards, in a predetermined time period.

In another general aspect, there is provided a method of controlling packet flow through a switch fabric that forms one or more switching stages, including: transferring packets corresponding to a predetermined window size among a plurality of segmented packets to the switch fabric such that the packets are transferred along different switching paths in the switch fabric; and receiving packets corresponding to the predetermined window size among two or more segmented packets transferred along different switching paths in the switch fabric.

In another general aspect, there is provided a method of configuring Acknowledge (ACK) messages in at least one destination card that has received packets through a switch fabric forming one or more switching stages, including: including a sequence ID and one or more flags in an ACK message that is piggybacked in a data cell, the sequence ID representing an order of a packet, wherein the flag include a S flag for indicating the first ACK message among successive ACK messages output from a Traffic Manager of Output (TMO), and a F flag for indicating the first destination line card that transfers the corresponding ACK message.

Other features and aspects will be apparent from the following detailed description, the drawings, and the claims.

### BRIEF DESCRIPTION OF THE DRAWINGS

FIG. 1 shows an example of a multi-stage switch.

FIG. 2A is a diagram illustrating the internal configuration of a source line card.

FIG. 2B is a diagram illustrating the internal configuration of a destination line card.

FIG. 3A shows a configuration of a Traffic Manager of Input (TMI).

FIG. 3B shows a configuration of a Traffic Manager of Output (TMO).

FIG. 4 shows an example of a ring structure.

FIG. 5 shows an example of unit data that is transmitted through links formed between switch modules.

FIG. 6 shows an example of a fabric switch structure having a cyclic switching pattern.

FIG. 7 is a flowchart illustrating an example of a method of controlling packet flow through a switch fabric including one or more switching stages.

FIG. 8 is a flowchart illustrating an example of a method of configuring acknowledge (ACK) messages in one or more destination line cards that have received packets through a switch fabric including one or more switching stages.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

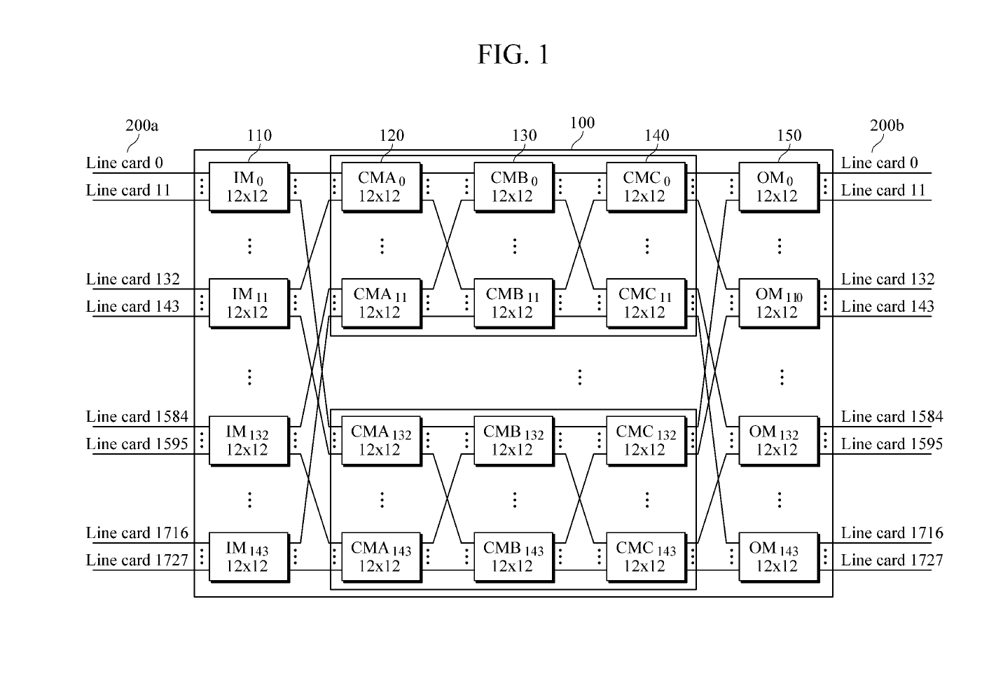

FIG. 1 shows an example of a multi-stage switch.

Referring to FIG. 1, the multi-stage switch includes a 5-stage Clos switch fabric 100.

Switch modules configuring the 5 stages of the 5-stage Clos switch fabric 100 includes input modules (IM) 110, center modules A (CMA) 120, center modules B (CMB) 130, center modules C (CMC) 140, and output modules (OM) 150.

The IM 110, CMA 120, CMB 130, CMC 140, and OM 150 have the same function. The switch modules have the same number of input and output ports.

Generally, in a multi-stage Clos switch fabric, the relation between the number N of switch ports, the size n of each switch module, and the number S of stages can be defined as Equation 1, below.

$$S = 2 \cdot i + 1 \\ ( ∀ i = 1 , 2 , 3 , … ) \\ N = {n}^{\frac{S + 1}{2}} \qquad ( 1 )$$

However, there may be differences in packet scheduling between stages, in complexity of implementation, and in performance according to whether the switch modules are bufferless or buffered switch modules.

For example, if the switch modules are bufferless switch modules, contention occurs between packets output from the switch modules of a stage before the packets are transferred to the switch modules of the next stage. As the capacity of a switch increases and the transfer rate of links between switch modules increases, a problem related to contention between packets is serious.

Meanwhile, if the switch modules are buffered switch modules, since packets output from the same ports of the switch modules are temporarily stored in local buffers, no requirements for contention resolution between the switch modules of different stages may be needed.

Accordingly, in the current example, the switch modules are buffered switch modules having better expendability than bufferless switch modules.

Referring again to FIG. 1, line cards 200a and 200b are provided in the input and output terminals of the multi-stage switch 100. The number of the line cards 200a corresponds to the number of input ports of the multi-stage switch 100, and the number of the line cards 200b corresponds to the number of output ports of the multi-stage switch 100.

Referring to FIG. 1, since the multi-stage switch 100 has 1,728 input ports and 1,728 output ports, 1,728 source line cards 200a and 1,728 destination line cards 200b are provided in the input and output terminals of the multi-stage switch 100.

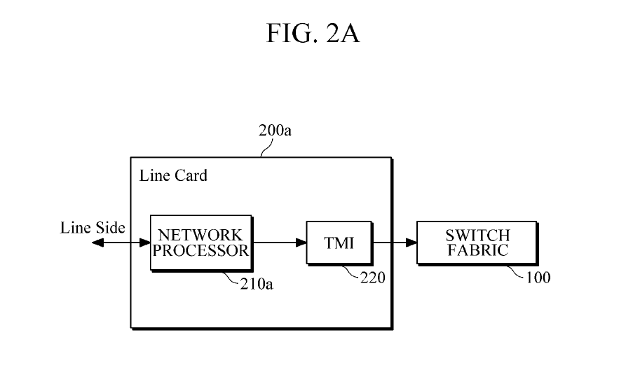

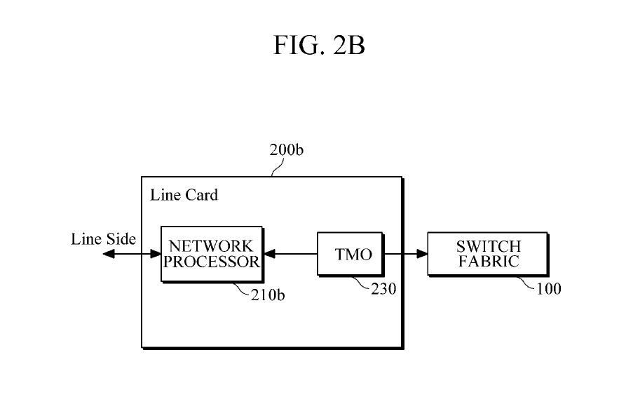

FIG. 2A is a diagram illustrating the internal configuration of each source line card 200a.

Referring to FIG. 2A, the source line card 200a includes a network processor 210a and a Traffic Manager of Input (TMI) 220. If a packet is received by the source line card 200a, the network processor 210a selects a destination line card 200b to which the packet is to be transferred. In the current example, all packets are assumed to have the same size, and a variable packet is segmented in units of cells having the same size. If the TMI 220 receives a plurality of packets, the TMI 220 distributes the packets to different switching paths in the switching fabric 100.

FIG. 2B is a diagram illustrating the internal configuration of each destination line card 200b.

Referring to FIG. 2B, the destination line card 200b includes a network processor 210b and a Traffic Manager of Output (TMO) 220.

Packets received by each source line card 200a are transferred to the corresponding destination line card 200b through a plurality of switching paths of the switching fabric 100. The TMO 230 of the destination line card 200b collects two or more packets transferred through different switching paths, arranges the order of the packets, and then transfers the reordered packets to the network processor 210b.

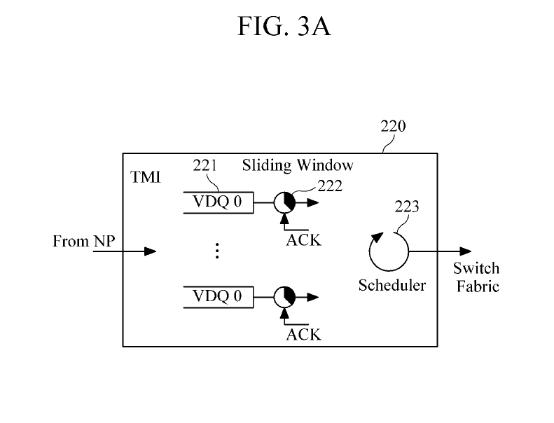

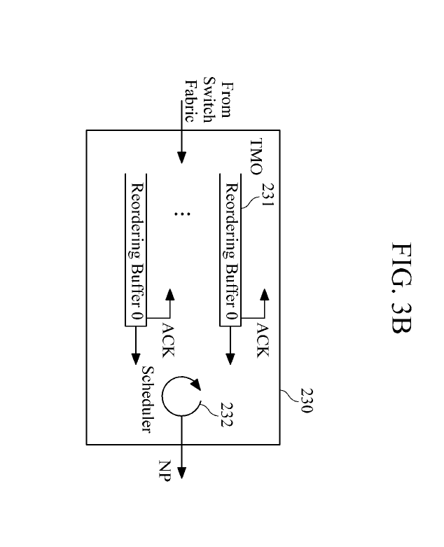

FIG. 3a shows a configuration of the TMI 220.

Referring to FIG. 3A, the TMI 220 includes N virtual destination queues (VDQs) 221 corresponding to N destination line cards 200b, a sliding window 222, and a scheduler 223.

Packets segmented by the network processor 210a are stored in VDQs 221 mapped to destination line cards to which the corresponding packets are to be transferred. Then, the VDQs 221 writes the identifiers of the corresponding destination line cards in the stored packets, respectively, and then outputs the resultant packets to the scheduler 223. Then, the scheduler 223 l outputs the packets to the switch fabric 100.

FIG. 3b shows a configuration of the TMO 230.

Referring to FIG. 3B, the TMO 230 includes N reordering buffers 231 matching N source line cards 200a. The reordering buffers 231 are used to restore the order of packets in the destination line card 200b.

However, the multi-stage switch fabric structure described above may have the following problems.

First, overload may occur in the reordering buffers of a TMO.

Since a Clos switch fabric has a multi-stage switch structure between a source line card and a destination line card, a plurality of switching paths exist. That is, packets received by the source line card are transferred to the destination line card through the plurality of switching paths. However, since the plurality of switching paths have different transfer rates, queue delay occurs. Accordingly, the order of packets included in the same flow changes, and the packets reach the destination line card in the wrong order. Accordingly, in order to restore the original order of the packets, it is necessary to provide reordering buffers in the TMO of the destination line card. However, as described above, since the transfer rates of the switching paths are different from each other, overflow may be generated in a specific reordering buffer.

Second, hotspot congestion may occur.

If overload is applied to a specific destination line card, the overloaded destination line card pushes a received packet to the switch fabric. Accordingly, the packet prevents transfer of other packets to the other unoverloaded destination line cards, which is called hotspot congestion.

In order to overcome the above-described problems that can be caused in a switch fabric, an end-to-end flow control method based on a window is proposed.

According to the end-to-end flow control method based on the window, in order to overcome the first problem described above, each VDQ 221 limits the number of packets that are transferred to the switch fabric 100, using a sliding window having a size of W. For limiting the number of transfer packets, the VDQs 221 of the TMI 220 communicate with the reordering buffers 231 of the TMO 220 for a control using the sliding window.

Also, according to the end-to-end flow control method based on the window, in order to overcome the second problem described above, by adjusting the rate of traffic entering the switch fabric 100 is it possible to prevent excessive packets from blocking inter-traffic.

The end-to-end flow control method based on the window is similar to a window control method used in a TCP protocol.

Hereinafter, an end-to-end flow control method based on a window, which is used in a multi-stage buffered Clos switch fabric, will be described.

Each VDQ 221 included in the TMI 220 uses two sequence numbers nₛ and nₐ, wherein nₛ represents the serial number of a next packet that is to be transferred, and nₐ represents the identifier of an acknowledge (ACK) message that has been finally received. According to an example, each VDQ 221 allows a packet stored therein to be transferred to the Clos switch fabric 100 only when nₛ−nₐ<W. All packets that are transferred to the Clos switch fabric 100 have sequence IDs representing the orders of the packets so that the packets can be transferred to destination line cards matching source line cards that have received the packets.

Meanwhile, each reordering buffer 231 included in the TMO 230 also uses two sequence numbers n_{d} and nₐ, wherein n_{d} represents the serial number of a next packet that is to be received, and nₐ represents the serial number of a packet in response to which an ACK message has been finally sent.

Each reordering buffer 231 is implemented as a ring structure, and the ring structure has W slots corresponding to a maximum number of packets, wherein W corresponds to a window size that is used by the VDQs 221. In the ring structure, writing can be performed with respect to all the slots, whereas reading can be performed only with respect to the head of the ring. The reordering buffer 231 maintains a pointer n_{d} indicating a sequence ID located at the head of the ring structure, that is, a pointer n_{d} of an expected in-order packet. If a new packet is received by the recording buffer 231, the packet is inserted into the corresponding slot of the ring based on the sequence ID of the packet.

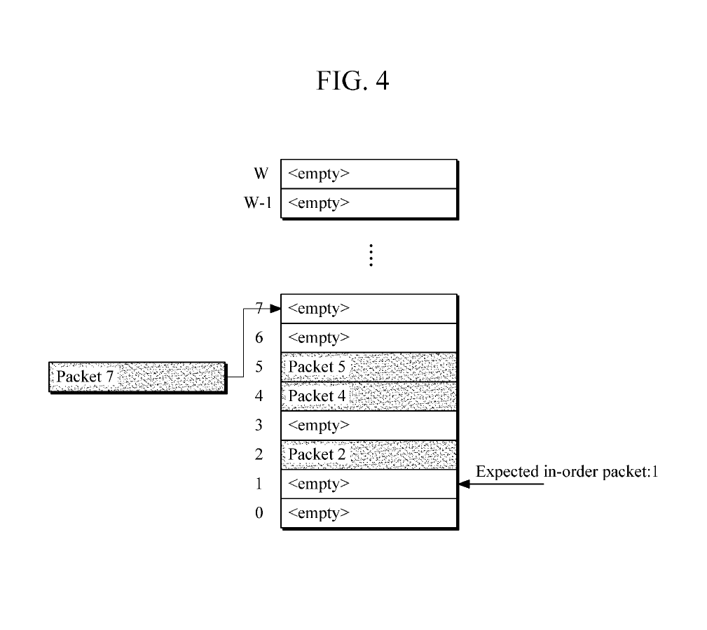

FIG. 4 shows an example of the ring structure.

Referring to FIG. 4, the reordering buffer 231 having the ring structure determines whether a slot indicated by an expected in-order pointer is filled with a packet, at every time slot. If it is determined that the slot has been filled with a packet, the reordering buffer 231 transfers the packet filled in the slot to the network processor 210b, and increase the number of a slot indicated by the expected in-order pointer by one.

Then, a TDM-based response method for end-to-end flow control will be described.

Each reordering buffer 231 included in a TMO 230 has to notify information about a packet which the reordering buffer 231 has finally received, to a VDQ 221 of a TMI which has transferred the packet. In an actual switch design, the TMI of an input terminal is disposed to match the TMO of the corresponding output terminal on the same line card. Accordingly, a path along which an ACK message is transferred from TMO i to TMI j is TMO i→TMI j→IM→CMA→CMB→CMC→OM→TMO j→TMI j. Here, TMO i and TMI i represent TMO and TMI on a line card i, respectively.

In order to use no additional connection lines in the Clos switch fabric 100 when an ACK message is transferred, the ACK message is piggybacked in a data cell before the data cell is sent to a link of the Clos switch fabric 100.

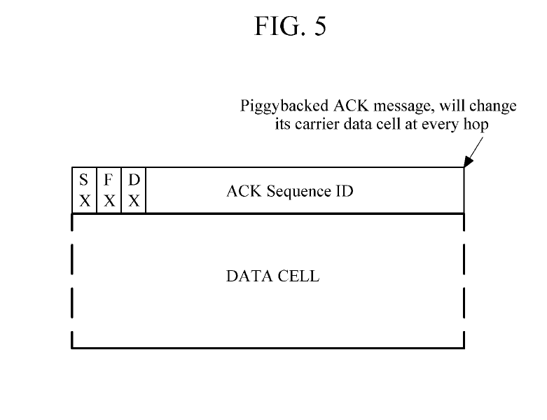

FIG. 5 shows an example of unit data that is transferred through links formed between switch modules.

Referring to FIG. 5, each ACK message is composed of a sequence ID and 3 bits of flags. After a piggybacked ACK message is transferred though links and received by a switch module, the piggybacked ACK message is separated from its data cell and then processed by a separate logical structure. That is, a piggybacked ACK message changes its data cell at every hop.

The following description relates to a TDM-based switching method in which ACK messages are transferred from a plurality of TMOs to a plurality of TMIs. In the TDM-based switching method, switching modules use a cyclic switching pattern in order to switch ACK messages, and accordingly, each TMO may transfer an ACK message to the corresponding TMI in N time slots. Accordingly, the N time slots are defined as an ACK cycle. However, since all the line cards and the switch modules operate independently and asynchronously, the individual line cards may start ACK cycles at different times, respectively.

In the t-th time slot (0≦t≦N−1) of an ACK cycle, a TMO 230 transfers an ACK message to a TMI t. That is, the individual TMOs 230 send N ACK messages to the corresponding line cards in an ACK cycle. However, the ACK messages have no routing information. In order to inform that N successive ACK messages are transferred, the “S” flag of the first ACK message is set as shown in FIG. 5. Then, the ACK message is routed to a desired line card by a cyclic switching pattern of the switching modules.

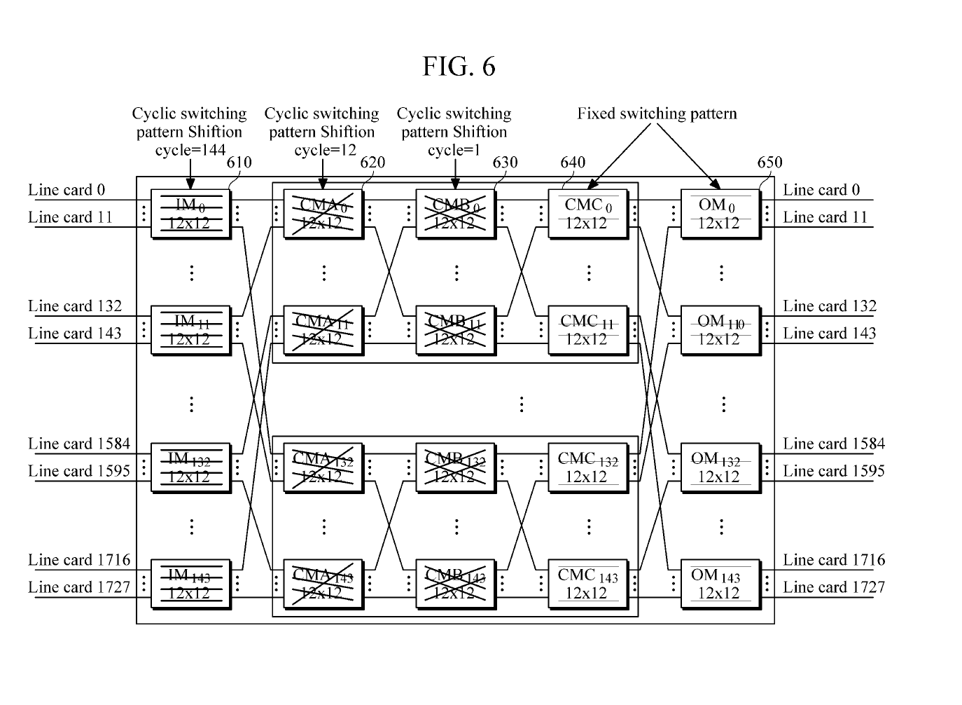

FIG. 6 shows an example of a fabric switch structure having a cyclic switching pattern.

In order to ensure all data transfer from a TMI to a TMO, switching modules belonging to different stages have to operate with different change periods. A change period is defined as a time period for which each switching connection pattern is maintained. For example, when a combination of switching modules, as shown in FIG. 6, is used, the switching modules operate as follows.

OM 650 and CMC 640 use a fixed switching pattern, for example, a switching pattern in which an input m is always connected to an output m, and IM 610 uses a switching pattern having a change period of n². In the example of FIG. 6, n=16. That is, when a time slot is t, an input m is connected to an output (m+(t div n²)) mod n. CMA 620 uses a cyclic switching pattern having a change period of n, wherein in a time slot t, an input m is connected to an output (m+(t div n²)) mod n. CMB 630 uses a cyclic switching pattern having a change period of 1, wherein in a time slot t, an input m is connected to an output (m+t) mod n.

Referring to FIG. 6, at every ACK cycle, each TMO generates 1,728 ACK messages in correspondence to 1,728 TMIs. If the 1,728 ACK streams are received by IM 610, each ACK stream is segmented into 12 144-ACK streams, and the 12 144-ACK streams are sent to the 12 output ports of the IM 610, starting from the first output port, through a cyclic switching pattern.

Then, if the 144-ACK streams are received by the CMA 620, each 144-ACK stream is segmented into 12 12-ACK streams through a local cyclic switching pattern. The 12 12-ACK streams are transferred to the 12 output ports of the CMA 620, starting from the first output port. Likewise, each 12-ACK stream is again segmented into 12 1-ACK streams in CMB 630. Thereafter, the 1,728 ACK streams pass through CMC 640 and OM 650, through fixed switching patterns, and reach the predetermined TMIs, respectively.

However, all the line cares and the switch modules operate independently and asynchronously, and also the switch modules have different transfer delay times. For example, the distances between IM 610 and CMA 620 may be different from each other by dozens of or hundreds of meters. Accordingly, by arranging the transfer delay difference between the switch modules and synchronizing ACK messages in the upstream switch modules, the ACK messages have to be transferred to predetermined output ports of the switch modules.

For this, in the current example, as shown in FIG. 5, each ACK message includes a synchronization flag “S”. The “S” flag indicates whether or not the corresponding ACK message is the first ACK message of a received stream, and is used to transfer the first lower stream to the output 0 of the corresponding switch module. Here, the “stream” is defined as successive ACK messages output from the same TMO, that is, the same line card. As such, by using the “S” flag to delay the ACK stream to be transferred, each switch module requires only a small size of buffer to arrange transfer delay at each input port.

Whenever each switch module receives a stream (distinguished from another stream by a synchronization flag “S”), the switch module segments the stream into sub streams having the same size, and transfers the sub streams to the output ports of the switch module, respectively, starting from the first output port. In order to identify a stream received by the switch module at the next hop, each switch module has to set the synchronization flag “S” of the first ACK message of the lower stream.

Another problem related to ACK transfer based on TDM is that each TMI receives 1,728 ACK messages from all TMOs at every 1,728 time slots. At this time, it is necessary to distinguish a TMO that has transferred a specific ACK message from the other TMOs. Accordingly, as shown in FIG. 5, an ACK message whose flag “F” has been set is used.

The “F” flag allows the TMI to identify a TMO that has transferred the corresponding ACK message. The 1,728 successive ACK messages reach the TMI in a predetermined order. If a TMO that has transferred a specific ACK message can be identified, the other TMOs that have transferred all the ACK messages also can be identified according to the predetermined order. Accordingly, by setting the “F” flags of all ACK messages transferred from the TMO 0, the TMI can easily identify all TMOs that have transferred ACK messages.

Also, according to ACK transfer based on TDM, the ACK messages have to be transferred between the switch modules in all time slots. Accordingly, in order to transfer the ACK messages, it is necessary to transfer data cells through all links between the switch modules in all time slots. If there is no data cell on which an ACK message will be carried, a switch module creates a dummy data cell, and sets the flag “D” of an ACK message which will be carried on the dummy data cell to represent that the data cell is invalid.

FIG. 6 shows a 5-stage Clos switch fabric, however, this is only exemplary. A method that will be described below can be applied to a general Clos switch fabric regardless of the number of stages and a module size. Accordingly, a TDM-based response mechanism that can be applied to a general Clos switch fabric regardless of the number of stages and a module size will be described below.

A Clos network switch having the number of stages of S=2·i+1(∀i=1,2,3, . . . ) and consisting of n×n switch modules is considered. Here, the total number of switch ports is

$$N = {n}^{\frac{S + 1}{2}} .$$

A TMO k represents the TMO of a line card k (0≦k≦N−1). At every ACK period each composed of N time slots, a TMO k sends ACK messages to N TMIs, starting from a TMI 0, using the Round-Robin method. The flag “S” of the first ACK message sent to the TMI 0 is set, and the flags “S” of all the remaining ACK messages are reset. Also, the flags “F” of ACK messages sent from the TMO 0 are set, and the flags “F” of ACK messages sent from the other TMOs are reset.

ACK messages that are sent to a switch fabric in all time slots are piggybacked in data cells and then transferred. If there is no data cell to be transferred, a dummy data cell is created and the flag “D” of an ACK message that will be carried on the dummy data cell is set.

If a switch module k (0≦k≦N−1) is the k-th switch module of the Clos switch fabric and

$$k > \frac{S - 1}{2} ,$$

the switch module k uses a fixed switching pattern. For example, an input m (0≦m≦n−1) is always connected to an output m. An ACK message received by the input m (0≦m≦n−1) is transferred directly to the output m. Meanwhile, if

$$k < \frac{S - 1}{2} ,$$

a switch module k uses a cyclic switching pattern having a change period of

$${n}^{\frac{S - 1}{2} - k} .$$

That is, in a time slot t, an input m is connected to an output

$$( m + ( t div {n}^{\frac{S - 1}{2} - k} ) )$$

mod n.

A switch module k delays an ACK stream received by an input m using a synchronization buffer to arrange streams, and sets the flag “S” of the corresponding ACK message when the input m is connected to the output 0, so that the first ACK message of each stream is always connected to the output 0.

Whenever the switch module k changes a switching pattern, the first ACK message that is transferred to an output port is marked. That is, the flag “s” of the first ACK message of each ACK stream that is transferred on a link is set. At every time slot, an ACK message that is sent to each output is piggybacked in a data cell. If there is no data cell to be transferred, a dummy data cell is created, and the flag “D” of an ACK message that will be carried on the dummy data cell is set.

A TMI k represents a TMI located on a line card k (0≦k≦N−1). The TMI k detects an ACK message whose flag “F” has been set and sends the ACK message to a VDQ 0. N−1 ACK messages received after the ACK message whose flag “F” has been set are sent to the corresponding VDQs using the Round-Robin method.

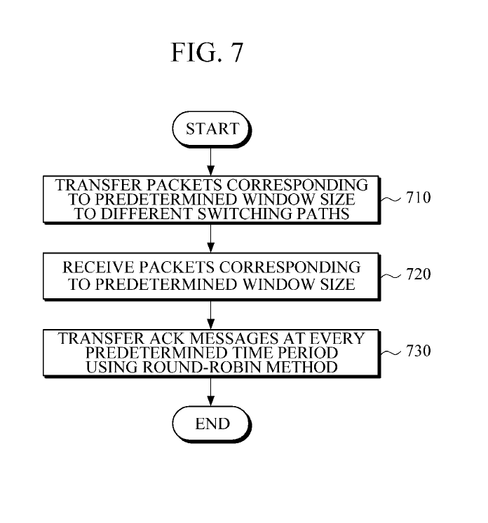

FIG. 7 is a flowchart illustrating an example of a method of controlling packet flow through a switch fabric including one or more switching stages.

Referring to FIG. 7, in operation 710, packets corresponding to a predetermined window size are extracted from a plurality of segmented packets and transferred to different switching paths in a switch fabric.

Then, in operation 720, packets corresponding to the predetermined window size are received from among two or more segmented packets transferred to different paths through the switch fabric.

After the packets are received, in operation 730, ACK messages are transferred to the switch fabric in a predetermined time period, using the Round-Robin method. At this time, only when the difference between the (serial?) number of a next packet that is to be transferred and the identifier of an ACK message that has been finally received is equal to or smaller than the predetermined window size, the corresponding packet is transferred to the switch fabric. Also, each ACK message is piggybacked in a data cell that is transferred to the switch fabric.

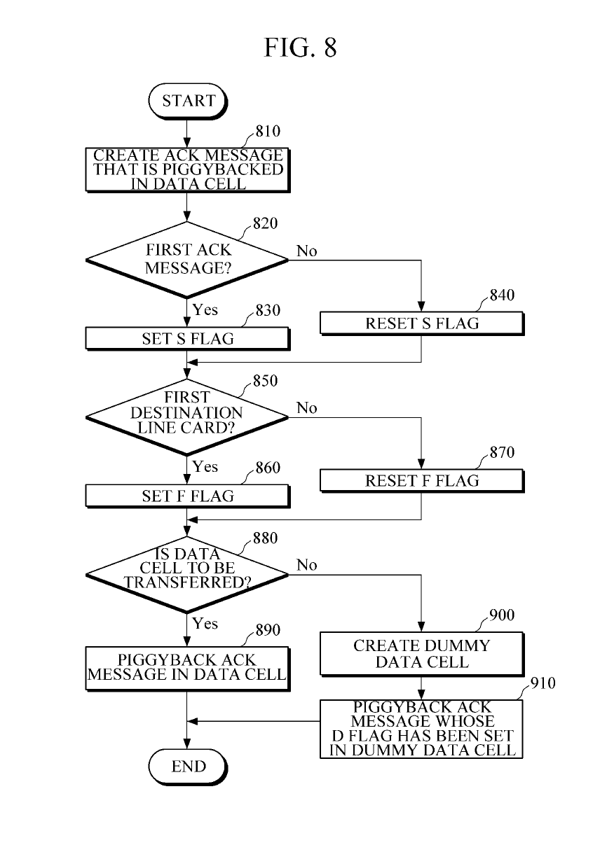

FIG. 8 is a flowchart illustrating an example of a method of configuring ACK messages in at least one destination line card that has received packets through a switch fabric including one or more switching stages.

In operation 810, the destination line card includes a sequence ID representing the order of a packet, and at least one flag, in an ACK message that is piggybacked in a data cell.

In operation 820, the destination line card determines whether the ACK message is the first ACK message of an ACK stream.

If it is determined that the ACK message is the first ACK message of the ACK stream, in operation 830, the destination line card sets the flag “S” of the ACK message.

On the contrary, if it is determined that the ACK message is not the first ACK message of the ACK stream, in operation 840, the destination line card resets the flag “S” of the ACK message.

Then, in operation 850, the destination line card determines whether itself is the first destination line card that transfers the ACK message.

If it is determined that the destination line card is the first destination line card that transfers the ACK message, in operation 860, the destination line card sets the flag “F” of the ACK message in order to inform that the destination line card is the first destination line card that transfers the ACK message.

However, if it is determined that the destination line card is not the first destination line card that transfers the ACK message, in operation 870, the destination line card resets the flag “F” of the ACK message

Then, in operation 880, the destination line card determines whether there is a data cell to be transferred.

If it is determined that there is a data cell to be transferred, in operation 890, the destination line card piggybacks the ACK message in the data cell.

However, if it is determined that there is no data cell to be transferred, in operations 900 and 910, the destination line card creates a dummy data cell, sets the flag “D” of the ACK message, and then piggybacks the resultant ACK message in the dummy data cell.

Comparing to a conventional method of transmitting ACK messages, the methods according to the current examples have the following effects.

First, since each TMI receives ACK messages from all TMOs at every N time slots, no ACK message is lost. Furthermore, since each ACK message includes no routing information, and has only a sequence ID of the corresponding packet and 3 bits of flags as overhead, no communication overhead is generated. In addition, since the methods according to the current examples require no synchronization between line cards or between switch modules, the methods can be easily implemented.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for controlling packet flow in a multi-stage switch, comprising:
one or more source line cards configured to receive one or more packets, and to transfer the one or more packets to a switch fabric including a plurality of switch modules forming one or more switching stages such that the one or more packets are transferred along different switching paths in the switch fabric; and
a destination line card configured to receive the one or more packets output from the switch fabric, and to transfer Acknowledge (ACK) messages for informing that the packets have been received, to the source line cards, in a predetermined time period.

2. The apparatus of claim 1, wherein each source line card comprises:
a network processor configured to segment a received packet, and to select a destination line card to which the segmented packet is to be transferred; and
a traffic manager of input (TMI) configured to distribute a plurality of packets output from the network processor to different switching paths in the switch fabric so that the packets are transferred along the different switching paths.

3. The apparatus of claim 2, wherein the TMI comprises:
a plurality of virtual destination queues configured to include identifiers of destination line cards to which a plurality of segmented packets received from the network processor are to be transferred, in the respective segmented packets, and to output the packets including the identifiers of the destination line cards; and
a sliding window configured to limit a number of packets that are to be transferred to the switch fabric; and
a scheduler configured to output packets output from the sliding window to the switch fabric, in an order in which the packets are output from the sliding window.

4. The apparatus of claim 3, wherein each virtual destination queue transfers a received packet to the switch fabric only when a difference between a serial number of a next packet that is to be transmitted and an identifier of an ACK message that has been finally received is equal to or smaller than a predetermined window size.

5. The apparatus of claim 2, wherein the destination line card comprises:
a Traffic Manager of Output (TMO) configured to collect the segmented packets transferred along the different switching paths through the switch fabric, and to arrange an order of the packets; and
a network processor configured to transfer the packets output from the TMO to the outside.

6. The apparatus of claim 5, wherein the TMO transfers the ACK messages to the source line cards at every predetermined time period.

7. The apparatus of claim 5, wherein the TMO comprises:
two or more reordering buffers configured to restore an order of the segmented packets received from the switch fabric, thus generating reordered packets; and
a scheduler configured to output the reordered packets to the network processor.

8. The apparatus of claim 7, wherein each reordering buffer has a ring structure, and inserts a received packet into a corresponding slot of the ring structure.

9. The apparatus of claim 7, wherein each reordering buffer determines whether a slot indicated by an expected in-order pointer is filled with a packet, at every time slot, transfers, if the slot has been filled with a packet, the packet filled in the slot to the network processor, and increases the number of a slot indicated by the expected in-order pointer by one.

10. The apparatus of claim 7, wherein the reordering buffers piggyback the ACK messages, respectively, in data cells that are transferred to the switch fabric.

11. The apparatus of claim 10, wherein each switch module receives a piggybacked ACK message and separates an ACK message of the piggybacked ACK message from a data cell.

12. The apparatus of claim 1, wherein each switch module switches a control message using a cyclic switching pattern.

13. A method of controlling packet flow through a switch fabric that forms one or more switching stages, comprising:
transferring packets corresponding to a predetermined window size among a plurality of segmented packets to the switch fabric such that the packets are transferred along different switching paths in the switch fabric; and
receiving packets corresponding to the predetermined window size among two or more segmented packets transferred along different switching paths in the switch fabric.

14. The method of claim 13, further comprising:
s transferring, after receiving the packets corresponding to the predetermine window size, ACK messages through the switch fabric.

15. The method of claim 14, wherein the transferring of the packets corresponding to the predetermined window size comprises transferring a received packet to the switch fabric only when a difference between a serial number of a next packet that is to be transmitted and an identifier of an ACK message that has been finally received is equal to or smaller than the predetermined window size.

16. The method of claim 14, wherein the transferring of the ACK messages comprises piggybacking the ACK messages, respectively, in data cells that are to be transferred to the switch fabric.

17. A method of configuring Acknowledge (ACK) messages in at least one destination card that has received packets through a switch fabric forming one or more switching stages, comprising:
including a sequence ID and one or more flags in an ACK message that is piggybacked in a data cell, the sequence ID representing an order of a packet,
wherein the flag include a S flag for indicating the first ACK message among successive ACK messages output from a Traffic Manager of Output (TMO), and a F flag for indicating the first destination line card that transfers the corresponding ACK message.

18. The method of claim 17, wherein if an ACK message to be transferred is not the first ACK message among the successive ACK messages output from the TMO, the S flag of the ACK message is reset, and if a destination line card that transfers the ACK message is not the first destination line card that transmits the ACK message, the F flag of the ACK message is reset.

19. The method of claim 17, wherein if there is no data cell to be transferred, a dummy data cell is created, and the flag further includes a D flag for informing that the corresponding ACK message has been piggybacked in the dummy data cell.
